(19) United States
(12) Patent Application Publication
(10) Pub. No.: US 2007/0281194 A1
(43) Pub. Date: Dec. 6, 2007

(54) Portable fuel cell assembly

(76) Inventors: Jeffrey Earl Cortright, Corning, NY (US); Dell Joseph St Julien, Watkins Glen, NY (US)

Correspondence Address: CORNING INCORPORATED, SP-TI-3-1, CORNING, NY, 14831, US

(21) Appl. No.: 11/786,305

(22) Filed: Apr. 11, 2007

Related U.S. Application Data
(60) Provisional application No. 60/810,089, filed on May 31, 2006.

(51) Int. Cl. H01M 8/04; H01M 2/08; H01M 8/10

(52) U.S. Cl. 429/26; 429/30; 429/36

(57) ABSTRACT

A portable solid oxide fuel cell assembly comprising: (i) at least one multi-cell device formed at least in part by a compliant electrolyte sheet; (ii) a frame module supporting the device, said frame module providing air and fuel to the device, the frame forming, in conjunction with the device at least one of: a single fuel chamber, a single air chamber adjacent to the active area of the at least one multi-cell device;
wherein said at least one multi-cell device generates more than 5V of electricity and has a maximum dimension of no more than 0.5 meter.

This application claims the benefit of U.S. Provisional Application No. 60/810,089, filed May 31, 2006, entitled “Portable Fuel Cell Assembly.”

### BACKGROUND OF THE INVENTION

1. Field of the Invention

The present invention relates to portable solid oxide fuel cell (SOFC) assemblies and more particularly to designs for portable SOFCs wherein the portable SOFC assembly includes at least one fuel cell device supported by a frame connected to source of gaseous fuel that is provided to the interior of the assembly.

2. Description of Related Art

Many companies are pursuing PEM (polymer electrolyte membrane) fuel cell devices for portable applications. However, PEM systems are relatively inefficient and can utilize only one type of fuel—i.e., pure H₂.

Although SOFCs can be more efficient, and can be more flexible in the fuel they use then the PEM based devices, no portable SOFC devices are known.

Tubular SOFC designs are known. These include long and/or flattened tube designs, zirconia tubes with banded stripes on them to form voltage building arrays, and multi-cell flattened tube designs. Also known are a variety of SOFC designs utilizing planar electrolytes. The SOFC devices utilizing planar electrolytes typically employ thick (0.10 mm) electrolyte plates and single anode and cathode electrodes for each plate. The repeating cell unit usually includes a massive current collector that also functions as an air/fuel separator plate. The anodes of each cell face the cathodes of the next cell and the separator plate is required to keep the gaseous fuel and air from mixing. These SOFCs are arranged in a stack. The stack is large, heavy and not portable.

Newer planar designs incorporate thick anode supported plates of 0.3-1 mm thickness supporting thinner electrolyte layers of about 5-50 microns thickness that provide higher single cell performance. These also use a repeating cell unit that usually includes a massive current collector (i.e., an air/fuel separator plate). Again, the anodes face the cathodes of the next cell and the separator/interconnect plate is required to keep the gaseous fuel and air from mixing. Reference may be made to Minh, N. Q., “Ceramic Fuel Cells”, J. Am. Ceram. Soc., 76, 563-588 (1993) for a further review of these and other solid oxide fuel cells and manifold designs. These SOFCs are arranged in a fuel cell stacks. These fuel cell stacks are also large, heavy, relatively expensive to make, and are not portable.

Recent developments also include fuel cell stack designs incorporating thin ceramic electrolyte sheets. U.S. Pat. No. 5,273,837, for example, discloses a fuel cell stack design comprising sheets of thin, flexible ceramic material which are combined to form channeled structures. The metal, ceramic or cermet conductors are bonded directly to these flexible sheets, and numerous sheets with adjacently facing anode and cathode structures are arranged in the fuel cell stack. Other designs based on flexible electrolytes are disclosed in U.S. Pat. No. 6,045,935, wherein the electrolytes are provided in non-planar configurations to improve the mechanical resistance of the assemblies to thermal cycling and thermal shock. Neither one of these references teaches or suggests portable fuel cell devices.

### SUMMARY OF THE INVENTION

According to one aspect of the present invention the portable solid oxide fuel cell assembly comprises: (i) at least one multi-cell device; and (ii) a frame module supporting said device, the frame module providing air and fuel to the device, wherein the device has a maximum dimension of no more than 0.5 meter. Preferably this assembly includes no more than 2 multi-cell devices.

According to one embodiment, the portable solid oxide fuel cell assembly generates more than 5V of electricity and has an external seal sealing the device to the frame module. Preferably, the frame module includes an external recess for receiving sealant material. Preferably the portable solid oxide fuel cell assembly comprises a felt or a soft seal situated between said single multi-cell device and the frame module. This felt provides at least partial electrical insulation. Preferably, the frame module includes a heat exchanger for heating incoming fuel. Preferably, the frame module also includes a heat exchanger for heating incoming oxidant. Preferably the solid oxide fuel cell assembly has exterior dimensions of not larger than 9″×12″×3″ (24 cm×31 cm×8 cm).

According to one embodiment a portable solid oxide fuel cell assembly comprises: (i) at least one multi-cell device formed at least in part by a compliant electrolyte sheet; and (ii) a frame module supporting the device, the frame module providing air and fuel to the device, the frame forming, in conjunction with the device at least one of: a single fuel chamber, a single air chamber adjacent to the active area of the devices; wherein the at least one multi-cell device generates more than 5V of electricity and has a maximum dimension of no more than 0.5 meter and preferably less than 0.4 meter.

### DESCRIPTION OF THE DRAWINGS

The invention may be further understood by reference to the drawings, wherein:

FIGS. 1A-1C present schematic top sectional and side cross-sectional elevational views of a framed SOFC assembly provided according to the invention;

FIG. 2 presents a schematic cross-sectional view the exemplary SOFC device according to the invention;

FIGS. 3A-3D illustrate recesses in several embodiments of the frame module used in a fuel cell assembly;

FIGS. 4A-4B illustrate the SOFC assembly with an external heat exchanger;

FIG. 5 is a cross-sectional view of one embodiment of the SOFC assembly of the present invention;

FIG. 6 is a cross-sectional view of another embodiment of the SOFC assembly of the present invention; and

FIGS. 7A and 7B illustrate the temperature of one exemplary embodiment of the present invention and its performance under these temperatures;

FIG. 8 illustrates another embodiment of the present invention.

### DETAILED DESCRIPTION

The present invention provides small portable SOFCs (solid oxide fuel cells) that can be utilized in cars, portable computers, cell phones, or other devices. Portable SOFCs are more efficient and provide more fuel flexibility than PEM fuel cell devices. According to the embodiments of the present invention a portable SOFC assembly can have a simple manifolding for air and fuel supply, as few as a single oxidant chamber, a single fuel chamber and a single multicell fuel cell device and still provide over 0.5 Watt, preferably over 1 Watt, typically less than 1 kW, and more preferably between 15 and 300 Watts of electrical power.

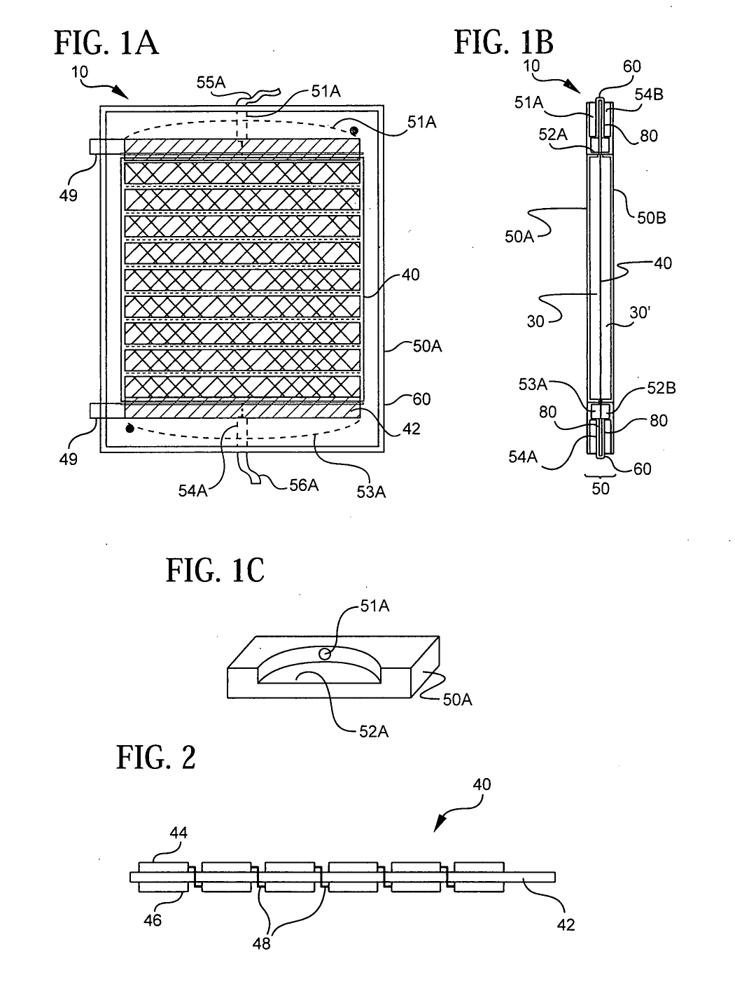

According to one embodiment of the present invention a portable SOFC assembly 10 depicted schematically in FIGS. 1A-1C comprises a single fuel chamber 30 and a single oxidant gas chamber 30′ formed by (i) a single multi-cell (electrolyte supported) fuel cell device 40 and (ii) a frame module 50 that supports the multi-cell fuel cell device 40. The multi-cell device 40 of this embodiment (see FIG. 2) includes an electrolyte sheet 42, a plurality of anodes 44 situated on one side of the electrolyte sheet 42 and a plurality of cathodes 46 situated on another side of the electrolyte sheet 42. The cathodes and anodes of this embodiment are interconnected by vias 48 that traverse through small holes in the electrolyte sheet 42. Preferably, the electrolyte sheet 42 is a flexible ceramic sheet. Preferably, the electrolyte sheet 42 is less than 45 μm thick, more preferably less than 25 μm thick and more preferably is 4-20 μm thick. Examples of suitable compositions for such electrolyte sheets 42 include partially stabilized zirconias or stabilized zirconias doped with a stabilizing additive selected, for example, from the group comprising of the oxides of Y, Ce, Ca, Mg, Sc, Nd, Sm, Eu, Gd, Th, Dy, Ho, Er, Tm, Yb, Lu, In, Ti, Sn, Nb, Ta, Mo, and W and mixtures thereof.

The following embodiments utilize frame modules 50 made of components that that have the appropriate thermal expansion, compatible to that of the electrolyte sheets 42, and/or the fuel cell devices 40. Exemplary ceramic electrolytes sheets 42 of 3 mole %-yttria-partially-stabilized zirconia composition have a average linear thermal expansion coefficient (CTE) of about 11.0 ppm/° C. in the temperature range of 25-750° C. Materials having use temperatures as high as 750° C. and with the required CTE are rare. Chrome-iron and Cr—Ni alloys are representative of alloys known in the art for use in fuel cell devices, both for interconnects and for framing materials. These alloy families include such metals as the above-described Plansee ITM alloy as well as Type 446 high chrome stainless steel (see Piron et. al., Solid Oxide Fuel Cells VII (2001). p. 811) Ferritic stainless steels have average CTEs in the range of 10-12 ppm/° C. (Metals Handbook (1948). Examples include Type 430 stainless steel containing 14-18% Cr, remainder Fe, with a reported CTE of about 11.2 ppm/° C. and a maximum use temperature of about 815° C., as well as Type 446 stainless steel containing 23-27% Cr, remainder Fe, with a CTE of about 11.0 ppm/° C. and a maximum use temperature of about 1110 C.

The portable SOFC assembly 10 may also include oxidant and fuel supplies or oxidant and fuel channels, for provision of oxidant and fuel to the device 40. The portable SOFC assembly 10 weighs less than 50 Kg, preferably less than 25 Kg, more preferably less than 10 Kg, even more preferably less than 5 Kg, and most preferably less than 2 or 1 Kgs. The portable SOFC assembly 10 is less than a 0.5 meters in its maximum dimension, preferably less than 0.4 meters, more preferably less than 0.33 meters and even more preferably less than 0.25 meters. Preferably, the SOFC assembly is not larger than a notebook (24 cm×30 cm×5 cm) and most preferably smaller than 12 cm×15 cm×2.5 cm. The SOFC assembly 10 advantageously utilizes an external seal 60. This seal 60 is, for example a frit seal or a blaze seal. This seal 60 is situated outside the chambers 30, 30′, and is removed as far as possible from the active areas (cells) of the device 40 and the reactive gases. That is, the seal 60 is not inside the fuel chamber, but is located remotely (relative to the active area of the SOFC assembly 10) and away from the chambers containing reactive gasses. Therefore, if the seal 60 is made of potentially reactive materials it is preferable to have it located outside the region of chemical activity and high heat (e.g., at, or near the outer surface of the frame module 50). The SOFC assembly 10 provides maximum output power of less than 1000 Watts, more preferably less than 300 Watts, and even more preferably between 0.5 Watt and 100 Watts. According to some embodiments the SOFC assembly 10 provides more than 0.5 Watt, preferably at least 5 Watts and more preferably at least 20 Watts of power. For example, SOFC assembly 10 may provide outputs of 1 W, 10 W, 20 W, 25 W, 50 W, 80 W, 125 W, 150 W, or 200 Watts.

The portable fuel cell 20 of the SOFC assembly of FIGS. 1A-1C, in contrast to prior art designs that employ flat planar cells, does not require the current collector/separator plate to fuel gas supply from the air supply in multiple cell assemblies. Effective fuel-air separation is instead achieved by the electrolyte sheet itself and the gas-tight via conductors 48 connecting the electrodes 44, 46 on either side of the electrolyte sheet 42. (See FIG. 2) This simplification reduces the number of gas chambers and seals by half or more, with a significant increase in reliability, simplified of assembly and lower manufacturing costs.

The multi-cell sheet devices 40 incorporated into the fuel cell assemblies 10 of the invention can be scaled up or down in size, as necessary, to achieve useful power outputs. Generally voltage levels of 20 volts or higher being favored over higher current levels at maximum output. A typical voltage per SOFC assembly 10 will be 2 to 3 volts or more, preferably more than 5 volts, more preferably at least 12 volts (for example, for battery charge applications) and even more preferably at least 48 volts (for example, for AC applications). In general, fuel cell assemblies of these designs will, at a minimum, retain these levels of power output after multiple (at least 5 or more) thermal cycles to operating temperatures in excess of 700° C.

The frame module 50 of the embodiment of FIGS. 1A-1C includes two frames 50A, 50B. A number of different frame constructions can usefully be employed for the construction of fuel cell assemblies 10 in accordance with the invention. For example, the frames 50A, 50B may be constructed of machined metal parts, or stamped metal framing can be used. Further, laminated frames incorporating combinations of metal and/or ceramic (glass, glass-ceramic and/or ceramic) materials can be used for better thermal expansion matching to the electrolyte sheets 42 or better compatibility with other elements of the SOFC assembly 10.

Oxidation resistant coatings can be applied to metal frames 50A, 50B or appropriate portions thereof to reduce metal oxidation and/or fuel cell contamination in use. In particular, such coatings can retard or prevent chromium transport to the supported electrodes in the cells. Examples of suitable coatings include those comprising one or more compounds selected from the group consisting of vanadates, niobates and tantalates. Also suitable are coatings formed of oxides selected from the group consisting of nickel oxide, magnesium oxide, aluminum oxide, silicon oxide, rare earth oxides such as those of Y and Sc, calcium, cobalt, or manganese oxide, barium oxide and/or strontium oxide.

The frame module 50 of FIGS. 1A-1C supplies fuel and air uniformly to the device 40 by means of inlet orifices 51A (fuel), 51B (air), distribution chambers 52A (fuel), 52B (air) such as a biscuit-cut gas expansion chambers, exit ports 53A (fuel), 53B (air) such as a biscuit-cut gas chambers, and final outlets 54A (fuel), 54B (air). FIG. 1B illustrates schematically that the frame 50A is a fuel frame and that the frame 50B is the air frame. The frames 50A, 50B also form, in conjunction with the fuel cell device 40, fuel chamber 30 and air chamber 30′. The fuel flows into the frame module 50 through the inlet orifice 51A which provides it to the fuel distribution chamber 52A (e.g. biscuit cut in the frame 50A) and then into the fuel chamber 30, pass the anode(s). The (at least partially) spent fuel is provided to the fuel exit ports 53A (e.g., a biscuit cut) and exits trough the final outlet 54A. The oxidant moves through the frame 50B in a similar manner. In the embodiment illustrated in FIGS. 1A-1C air and fuel move in a counter-flow direction. However, fuel/air co-flow and cross flow configurations are also possible.

Distribution chambers 52A, 52B (such as gas expansion chambers 52A, 52B in this embodiment) help to evenly distribute air flowing into the fuel and air chamber via inlet orifices 51A (fuel), 51B (air), while exit ports 53A, 53B provide expanded zones for the collection of exhaust fuel and air into final outlets 54A (fuel), 54B (air). In both of these fuel frame and air frame examples, the wedged or “biscuit” shape of the expansion chambers add sufficient frictional drag to ensure uniform flow.

The fuel cell device 40 is preferably supported by a soft seal 80 (typically alumina felt) inside the frame module 50. The soft seal material is, for example, an alumina based felt that may contain up to 50% silica, although felts containing less than 5% silica are preferred, and felts containing less than 3% are most preferable, because of possible cell contamination by silica. The soft seal 80 (e.g., alumina felt) provides at least partial electrical insulation between the device and the frame, and preferably displays a breakdown voltage of greater than 10V and, preferably greater than 50 V, more preferably greater than 60V, 75 V or 100V, and most preferably greater than 120V.

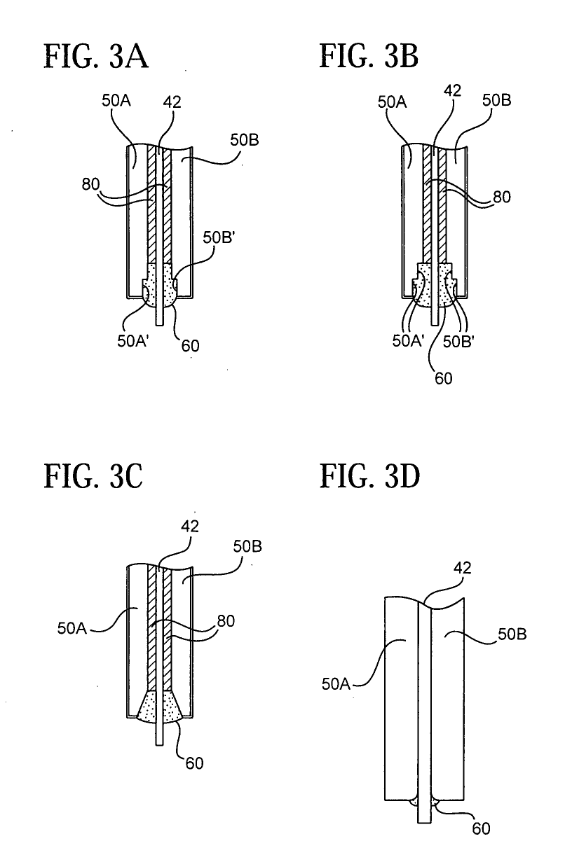

In this embodiment, each frame 50A, 50B is machined out of a single piece of metal, or cast, to create the fuel and air chambers 30, 30′ (inside center of the frame module 50) that contain the gasses, enable these gasses to flow past the device 40, and provide a means for supporting and sealing the devices 40. Preferably frames 50A, 50B include recesses 50A′, 50B′ in the outer edges of frames. (See FIGS. 3A-3D.) These external recesses 50A′, 50B′ can provide clearance for necessary sealing materials or optional thermal insulation materials used in construction of the fuel cell assembly, e.g., for sealing the electrolyte sheet edges to the frame module 50 and protecting the electrolyte sheets 42 from thermal damage.

The use of recesses 50A′, 50B′or thermal insulation such as soft seals 80 constitutes effective passive mechanisms for thermal gradient control within the fuel cell assemblies. The use of external frame recesses 50A′, 50B′ shown in FIGS. 3A-3D (and preferably recesses with multiple recess levels), wherein the electrolyte sheets 42 are edge-sealed to the frame modules 50 with the sealant material forming the seal 60 (preferably within the deeper level of such recesses) is quite effective. Additionally or alternatively, frames 50A, 50B with recess designs providing an increasing spacing between the electrolyte sheet 42 and frame 50A, 50B toward the frame opening into the fuel chamber can be used. Although frames with rectangular edges (with or without the recesses) may be utilized, frames 50A, 50B with beveled or radiused inner edges may also be utilized.

Air and fuel flow rates and pressures may be adjusted as desired to insure the efficient operation of the portable fuel. To avoid stress from pressure pulses or flow interruptions, bellows or other pressure pulse reduction devices may be included in the design of the SOFC assembly 10. Flow control elements, for example fuel injectors situated along the edges of the multi-cell sheet devices 40 can also help to minimize the effect of pressure pulses in the fuel cell assembly. This is described, for example, in U.S. application Ser. No. 11/399,677 filed on Mar. 31, 2006 in the name of Yi Jiang et al. which is incorporated by reference herein.

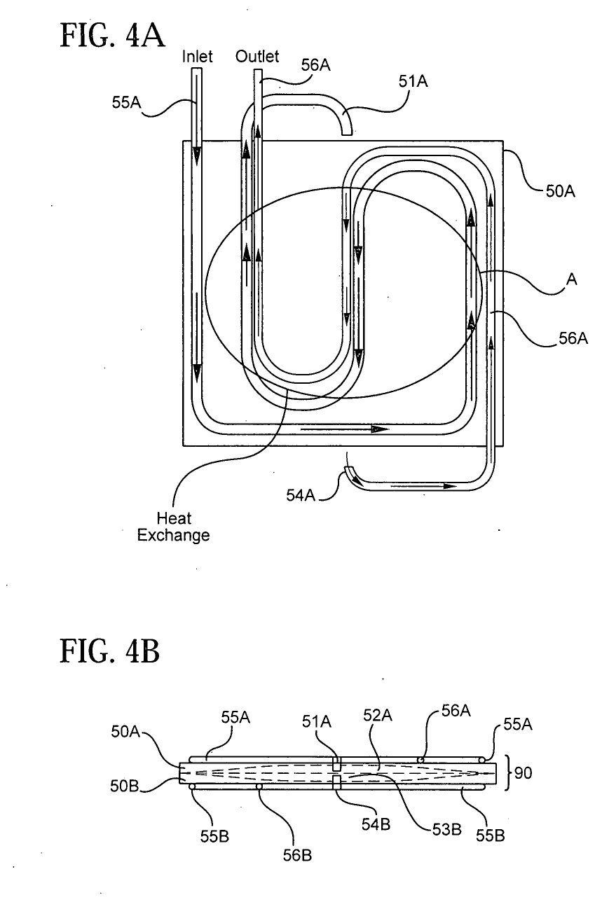

Manifolding for the supply of air and fuel gases for the fuel cell assembly 10 may also be provided. Such manifolding may be internal to the frame modules 50 or external thereto, and any combination of internal and external air and or fuel manifolding may be used (see, for example, FIGS. 4A, 4B). Additionally, for some designs, it may be useful to surround the SOFC assembly 10 with an enclosure or container to trap and recycle any air or fuel gases that may escape the SOFC assembly 10.

The use of frame modules 50 in the portable SOFC assembly 10 in accordance with some embodiments of the invention also offers a broader array of options for heat management and fuel stream processing than available in many other designs. For example, waste heat from the SOFC assembly can be used for heating inlet gases by incorporating a heat exchanger 90 (e.g., tubes 55A, 56A, 55B, 56B) into or proximate to a fuel manifold. Cold fuel gas flowing through the heat exchanger would thus be preheated prior to introduction into the fuel chambers in the stack.

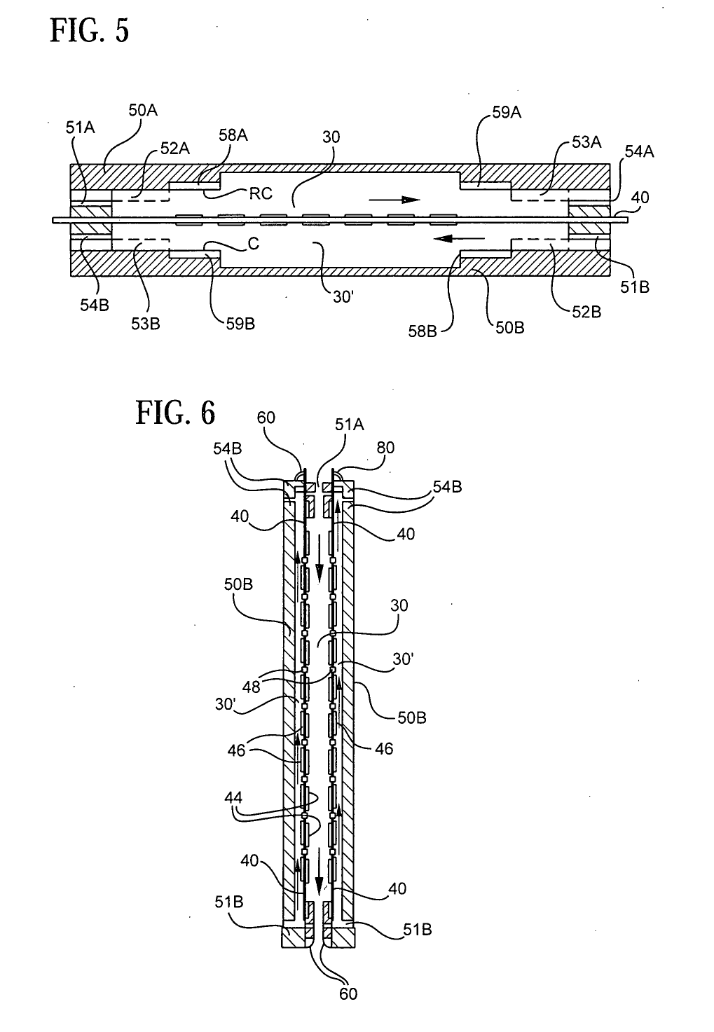

Heat exchangers or other gas chambers, e.g., for fuel gas reforming, can conveniently be incorporated directly into air or fuel frames, for example through the use of metal stampings as frame layers. For example (See FIG. 5), the frame 50A, could be provided with an elongated inlet section 58A providing chamber space between the gas expansion chamber 52A and the fuel chamber 30, and that chamber space could be provided with a reforming catalyst (RC) supported on the frame surface of the inlet section 58A, or with a catalyst-containing porous cellular material, wool, felt or high surface area honeycomb for increased surface area, mass transfer, or gas mixing. (FIG. 5) Similar inlet section 58B could incorporate catalysts (C) for partial catalytic oxidation reforming, pseudo-auto-thermal reforming and/or for steam reforming of hidrocarbons. Heat for any reaction that is endothermic could be provided by heated exhaust air in stack designs featuring counter-flow fuel-air distribution. Base metal catalysts such as Ni metal, precious metals, perovskites, and hexaluminates could be employed.

Similarly, extending the length of the exit port 53A, or providing a chamber 59A adjacent the fuel exhaust expansion chamber (or exit port 53A) would provide means for partial preheating of the inlet air. Structures such as fins (could be provided in frame chambers or conduits to improve heat exchange, or extruded metal honeycomb sections could be mounted therewithin. Chamber 59A may also contain catalysts (RC) for reforming.

Heat exchange may be enhanced by stamping frame to create circuitous internal paths for the gases traversing frame conduits. Gas paths so formed may reside at inlet or outlet ends of the frames or along the sides so as to ensure rapid uniform heat-up of the multi-cell-sheet devices. Heat exchange may also be performed in the gas distribution chambers, e.g., by insertion of suitable materials such as cellular materials, felts, wools or extruded metal monoliths. Similar modifications of manifold feeder tubes or foil distributors also may also be used to improve heat exchange and thermal management.

Partially spent fuel may be burned in air to create heat. Exhaust chamber(s) or conduit surfaces may be catalyzed or a catalyzed substrate, such as a coated felt or honeycomb, may be employed to reduce emissions of pollutants where spent fuel heat generation needs to be maximized. The catalysized chamber (for example, chamber 59A) may be supplied with air inlet(s) to facilitate combustion. The high voltage compact nature of these stacks make them ideal for mobile applications such as APUs for portable power. The employment of low mass frame components, in combination with the thin, low thermal mass multi-cell-sheet devices, is critical for those applications where start up times must minimized.

FIG. 4A, 4B illustrate one exemplary fuel manifold for the SOFC assembly of FIGS. 1A-1C that also acts as a heat exchanger 90. In this embodiment, the oxidant and fuel heater is located externally of the SOFC assembly 10. The heater provided the initial heating of gases to the operating temperature. The heat from the fuel exhaust is used to continuously heat the frame module and the active area(s) of the fuel cell device 40, thus reducing the heat loss from the device(s) 40. More specifically, the heat from the fuel exhaust is used to heat the incoming fuel and the heat from the spent oxidant is uses to heat the incoming oxidant (e.g., air). For example, the fuel gas enters the manifold (inlet tube) 55A of the heat exchanger 90 through the inlet orifice 57A and passes into the frame 50A through the inlet orifice 51A. In this embodiment, the incoming fuel inlet tube 55A is situated adjacent to the exhaust tube 56A of the heat exchanger 90. The exhaust tube 56A contains hot exhausted fuel that exits the frame through the final fuel outlet 54A. Thus, being adjacent to the fuel inlet tube 55A, the exhaust tube 56A preheats the incoming fuel entering into the frame. In addition, tubes 55A, 56A are situated in direct contact with the fuel frame 50A and are folded so that several sections of the tubes 55A, 56A are situated over or near the active area A of the device 40, heating the fuel frame 50A and the active area A of the device 40.

Thus, in the operation of a SOFC assembly 10, fuel from the fuel plenum or other sources may be supplied to the SOFC assembly 10 by means of tubes 55A affixed to frame module 50. The fuel then passes into the distribution channels formed by the aligned channels through the fuel frame(s) and from there through the flow-limiting inlet orifices 51A, distribution or gas expansion chambers 52A, and into the fuel chamber 30 to supply the anode arrays on the multi-cell-sheet devices 40. Partially spent fuel exits the fuel chamber 30 through the gas exit ports 53A (e.g., expansion zone) and into the final outlet 54A (exhaust conduits) formed by the aligned channels in the frames. In this way exhaust is collected and passes via tubes 56A into the exhaust plenums.

Similarly, in this embodiment, the oxidant enters the frame 50B through the inlet orifice 51B. The oxidant is supplied to the frame 50B by an incoming oxidant tube 55B of the manifold or heat exchanger 90. The oxidant enters the heat exchanger through the inlet orifice 57B and passes through the heat exchanger (e.g., incoming fuel tube 55A) prior to entrance into the frame 50B. In this embodiment, the incoming oxidant tube 55B is situated adjacent to the air exhaust tube 56B. The exhaust tube 56B contains hot exhausted air that exits the frame 50B through the final air outlet 54B. Thus, being adjacent to the air inlet fuel tube 55B, the exhaust tube 56B preheats the incoming air entering into the frame 50B. In addition, tubes 55B, 56B are situated in direct contact with the oxidant (e.g., air) frame 50B and are folded so that several sections of the tubes 55B, 56B are situated over or near the active area A of the device 40, heating the fuel frame 50B and the active area A of the device 40.

Thus, air may enter the SOFC assembly 10 from an air plenum and may be distributed via tubes such as 55B, through the frame module 50 via the channels formed by the (aligned) openings 5B in the air frames 50B. The air then passes through the orifices 51B and the distribution chambers 52B (e.g., expansion zones) and into and across air chamber 30′ where the air is partially depleted of oxygen. The depleted air then exits through gas collection zones (exit ports 53B and final 54B into the exhaust channels formed by the aligned channels (e.g., tubes 55A, 56A and/or 55B, 56B) in the air frames 50B, and from there tubes 56B′ into a depleted air plenum.

The portable SOFC assembly 10 may contain air and fuel flow components such as pumps and fans, means for atomizing/evaporating liquid fuels, and optionally electronics (and rechargeable electrical power supply) for controlling the various functions. The fuel cell assembly, heat exchanger and fuel processor are all insulated from the outside by very light but efficient insulation, good to approximately 800° C. Self sustaining heat is necessary, too little insulation is un-desirable. A thin metal frame is preferred to lighten the power supply. The portable SOFC assembly 10 takes advantage of the unique external or out of the fuel/air stream frame seal 60.

The portable SOFC assembly 10 may utilize fuel such as compressed gasses (bottled) like hydrogen, propane, butane, methane (compressed natural gas) and/or liquid fuels like methanol, ethanol and liquid hydrocarbons such as diesel fuel. With the chemically more complex fuels, the portable SOFC assembly may either utilize or contain a fuel processor and heat exchanger. Even in the absence of a fuel processing function, a heat exchanger to cool exhaust gasses and heat incoming air and/or gaseous fuel is preferred. The fuel cell assembly may also include a burner, or rechargeable battery and/or electric heater for starting the system from ambient temperature.

Another elementary construction for a fuel cell assembly 10 based on a multi-cell-sheet design is illustrated in FIG. 6 of the drawings which a side cross-sectional elevational view of that embodiment. The devices 40 include ten cells (per device 40), the cells being supported on a partially stabilized zirconia electrolyte sheets 42. The cells comprising 10 pairs of silver/palladium alloy electrodes 44, 46. The electrolyte sheet 42 is edge-sealed to the frame module 50, the seal being a gas-tight seal 60 formed of a conventional heat-sinterable ceramic sealing composition.

In this design each alloy electrode pair 44, 46 attached to the electrolyte sheet 42 includes an interior fuel electrode or anode 44 and an exterior air electrode or cathode 46, these being in largely overlapping positions on opposing sides of the electrolyte sheets 42. These anode-cathode electrode pairs are connected in series by electrically conductive metal alloy via 48 traversing the electrolyte sheet 42 from the extending edge of each anode 44 on the interior or fuel side of the electrolyte sheet to the extending edge of the next succeeding cathode in sequence on the air side of the sheet, as best illustrated in FIG. 6. The electrolyte sheets 42 are preferably supported within SOFC assembly 10 by a fibrous alumina mat 80 (soft seal) attached to the zirconia electrolyte sheets 42 with the ceramic sealing composition.

The multi-cell-sheet SOFC design approach above described has significant power-generating advantages, including an ability to build voltage rapidly to produce useful power from each multiple-cell-sheet device. For example, given a sheet with 100 electrode pairs, a maximum power density of 0.5 W/cm², and 500 cm² of active cell area can produce 250 W of electrical power at ˜50 V and 5 A. Power output at this relatively high voltage level means that relatively inexpensive leads, for example wires of relatively small cross-section, may be used, since I²R losses are minimized.

As previously noted, portable SOFC assembly construction is simplified by preferably utilizing edge-sealed or near-edge sealed devises (preferably comprising of opposing preferably multi-cell-electrolyte supported sheets) mounted on mechanically supportive, e.g., rigid or semi-rigid, frames by means of suitable glass, metal, composite or other seals. Such frames can provide open space between for air chambering, to facilitate air access to the cathodes. If desired, the frames can also contain internal manifolding with appropriate seals to accommodate fuel and/or air conduits for gas supply to interior and exterior surfaces of the devices 40. Thus channels within the frames can facilitate the introduction and exhaustion of hydrogen-containing fuel gases into and from the SOFC assemblies via tube(s), frame channels, or other conduit means.

The frame module 50 of FIG. 6 embodiment is formed of frames 50A, 50B made of a refractory ferrous metal alloy. The frame module 50 serves as a support for a first 10-cell (electrode/electrolyte sheet) fuel cell device 40, similar in design and construction to the multicell device 40 described above, and a second fuel cell device 40 of the same design, both forming a fuel chamber 30 therebetween. Each electrolyte sheet 42 is edge-sealed to the frame module 50 via seal 60, with its cathode array 46 facing outwardly and its anode array 44 facing into the fuel chamber 30 formed by the frame module 50 and attached electrolyte sheets 42.

In this embodiment, frames 50A, 50B are provided with fuel conduits 51A and air conduits 51B, these conduits operate as manifold components for servicing the SOFC assembly 10 with air and fuel. The air conduits 51B traverse frames 50B with no internal side porting, so that air or oxygen flow is channeled into the air chambers 30′ and past fuel chamber 30 with no access thereto. Fuel conduit 51A channel fuel gas flow through fuel chamber 30 between electrolyte sheets 42 of the two fuel cell devices 40. With this conduit arrangement, fuel gas entering fuel chamber 30 via conduits 51A traverses the chamber in the direction of arrows 5 wherein fuel oxidation occurs, and consumed fuel by-products are then exhausted from fuel chamber 30 via exhaust conduits 54A.

The above described embodiments of portable SOFC assemblies 10 reflect a number of advantageous design principles. First, the fuel cell assembly 10 approach utilizing multi-cell-sheet fuel cell array(s) does not require bipolar plate. Devices 40 may be sealed to by seal 60 to the frame module 50 using glass, glass-ceramic, metal, glass-metal, or cermet based sealing materials, creating a fuel “chamber” that is sealed with essentially rigid seals.

Two devices 40 may also be utilized to create a single fuel chamber 30 that lies between the devices 40. In this embodiment, two air chambers 30′ would be formed between the devices 40 and the air frames 50B. Alternatively, in a similar configuration (but with air and fuel frames reversed, a single air chamber 30′ will be formed when the two devices 40 are situated with their cathode sides facing one another, and the spaces between the two frames 50A and 50B and the devices 40 would be utilized as fuel chambers 30′. These approaches eliminates the need for the usual bipolar plate/interconnect structure and an added air/fuel separator.

As noted above, the frames 50A and 50B may carry internal channels that together can provide distribution manifolds for both gas and air. Gases may be fed to these distribution channels from internal or external plenums attached to the frame module 50, with orifices in the distribution channels provide access to the fuel or air cavities.

Other features of the portable fuel cell assembly of the invention contribute to limiting operating stresses on the device(s) 40. Primary stresses arising in the course of using these devices include thermal-mechanical and pressure-differential-induced stresses, the former being particularly problematic during device start-up and shut-down. Sources of thermal-mechanical stress include thermal expansion mismatch among the fuel cell assembly components, thermal lag (the frame heats more slowly than the rest of the device because of thermal mass), and thermal gradients from device operation. Leakage can also be a source of thermomechanical stress in that undesired burning of fuel creates local hot spots or general heating. Placing the seal 60 externally, with respect to the fuel chamber 30 on the outer portion of the frame module, and having the electrolyte sheet 42 expand through the frame module, help reduce mechanical and/or thermal stresses on the device(s) 40.

The maximum temperature differential across the fuel cell device 40 can be effectively reduced by adopting a counter-flow distribution scheme for the air and fuel gases. This scheme can physically move peak internal temperatures with respect to the discharge ends of the fuel cell assemblies. The resulting reductions in maximum temperature differentials across the assembly facilitates the maintenance of a much narrower operating temperature window, thereby maximizing cell performance and minimizing material degradation. This is particularly helpful for electrode designs incorporating silver or other materials adversely affected by over-temperature cell operation. Further, avoidance of maximum temperatures at device corners reduces biaxial stress, which is particularly difficult to control via geometric design measures such as corrugation of the multi-cell-sheet electrode arrays in the SOFC assemblies.

A further advantage of the counter-flow design is that it provides a more uniform electrochemical driving force across the electrolyte sheets 42, since the fuel is depleted at the location near the air inlet end, where the oxygen partial pressure across the membrane is a maximum.

As noted above, the material for the fabrication of frames should be selected with an appropriate thermal expansion coefficient, preferably one that places the attached multi-cell-sheet devices 40 in slight compression. This still permits frame fabrication from any one of a variety of available solid materials, or alternatively from combinations of materials, including mixed frame compositions as well as laminates of thick or thin frame-forming plates formed by means such as stamping or forging. Suitable frame construction methods include powder metallurgy processes or, in the case of glass or ceramic framing members, conventional ceramics processing techniques including melting, casting, pressing, sintering, or the like. Glass, ceramic, or other non-metal frames or frame components may be selected, for example, in cases where low thermal conductivity in the frame is tolerable or desired. Frame members formed of laminates of metals are useful to tailor thermal characteristics (such as CTE) or chemical properties (such as durability). The presently preferred frames are metal, although zirconia supports and/or alumina fiber mats can be used where lower thermal conductivity or improved high temperature oxidation resistance may be desired.

Stamped thin metal frames are generally economical and can be formed with 3-dimensional structure (relief) so that gas conduits and/or gas expansion chambers can be included in plate laminations as integral parts of the formed frames. Relief in the frames can additionally form structures for heat exchange or for accurate stacking as well as for gas flow.

The use of thin, low thermal mass frames provides the added benefits of reduced thermal lag between the frame and the device and rapid overall system heat-up. Frame plates, stamped components, and frame inserts may be employed. For example, inserts for the frames can be used where particularly accurate geometric tolerances are needed. For example, gas inlet orifices may benefit from accurate forming to insure a uniform flow of gas into each assembly. The use of thin stamped frames can also be a cost effective approach in that machining costs are minimized and space is not filled by metal but by air.

The importance of sealing in solid oxide fuel cell designs is well understood. Most critical are the seals serving to prevent the leakage of air into the fuel chamber, although the escape of fuel into the cathode side “working” area of the fuel cell is also to be avoided. That is, the fuel/anode seals need to be particularly robust, but the air/cathode seals may need not be as tight, and in fact designs can be envisioned wherein no or minimal sealing on the air side of the assembly is provided.

If the fuel cell assembly utilizes two devices 40, the seals critical for air exclusion from the anode arrays are those made between each multi-cell-sheet device and the frame structure to which it is attached. The frame structure adjacent the seal may play an important role in controlling seal stress arising from thermal gradients developed within the assembly during stack operation. Materials useful for forming the sheet-frame seals 60 may comprise any one of a variety of glass, glass-ceramic, metal, glass-metal, graded metal-to-glass, and graded metal-to-ceramic seals known in the art for bonding together compatible or physically incompatible metal and ceramic materials.

In some embodiments of the present invention the fuel expansion chambers 52A, 53A comprise biscuit cuts into the inside frame edges defining the peripheral edges of the fuel chamber 30. The biscuit cuts provided are of a depth extending sufficiently into the width of the frame edges that they intersect and provide flow communication with fuel conduits 51A and 54A (See FIGS. 1A and 1C).

Frame grooves may be utilized to accommodate current leads 49 to the devices 40 mounted on the frames 50A, 50B, being suitably insulated using inserts or encasements as hereinafter more fully described.

The present invention is not restricted to any particular families of electrode, current collector or cell interconnect materials. Thus structures such as are typically formed of wire or mesh of platinum, platinum alloy, silver, or other noble metal, nickel or nickel alloys can be used, as can coatings or patterned layers of these materials or materials such as strontium-doped lanthanum chromates or refractory metal cermets. These conductive structures may act as current collectors which are provided on top of, beneath, or along side electrode layers or they may act as interconnects between layers.

Among the electrode materials useful in combination with pre-sintered electrolytes are cermet materials such as nickel/yttria stabilized zirconia cermets, noble metal/yttria stabilized zirconia cermets, these being particularly useful, but not being limited to use, as anode materials. Useful cathode materials include such ceramic and cermet materials as strontium-doped lanthanum manganite, other alkaline earth-doped cobaltites and manganites, ferrites, as well as noble metal/yttria stabilized zirconia cermets. Of course the foregoing examples are merely illustrative of the various electrode and interconnect materials which could be used.

Cathode and anode materials useful for fuel cell construction in accordance with the invention are preferably composed of highly conductive but relatively refractory metal alloys, such as noble metals and alloys amongst and between the noble metals, e.g., silver alloys. Examples of specific alloy electrode compositions of this type include silver alloys selected from the group consisting of silver-palladium, silver-platinum, silver-gold and silver-nickel, with the most preferred alloy being a silver-palladium alloy.

Alternative electrode materials include cermet electrodes formed of blends of these metals or metal alloys with a polycrystalline ceramic filler phase. Preferred polycrystalline ceramic fillers for this use include stabilized zirconia, partially stabilized zirconia, stabilized hafnia, partially stabilized hafnia, mixtures of zirconia and hafnia, ceria with zirconia, bismuth with zirconia, gadolinium, and germanium.

Examples of other design elements that may be included in these fuel cell assemblies 10 are low resistance current collecting grids or other conductive structures provided in electrical contact with the arrayed anodes and/or cathodes. These can operate to reduce the internal resistance of the cells by reducing current distribution losses within the electrodes that would otherwise increase that resistance.

Electrical interconnections between devices can be made externally or internally as desired. And, whether an insulator or a conductor, the frames may play important roles in the circuit design of the stack. If the frame is an insulator, such as glass or glass-ceramic, then it will support electrical lead insertion without shorting. If the frame is a metal it can either participate in the circuit, for example by providing a common ground, or it may be insulated from electrical current leads by coatings, inserts, insulated tubes.

It is also advantageous to employ more than one point of power take-off from each sheet device, in order to reduce the current through each take off and the distance that must be traversed from the cells to the lead connection. At lower currents, the cross-section of the take off and of the leads may be reduced so as to limit material costs and thermal stress. Positioning power take-offs along the edges of the assembly rather than at the assembly ends also helps to avoid gas flow disruptions at the inlet and exhaust openings of the chambers, although depending on the geometry of the electrodes, this orientation can place the long axis of the cell electrodes parallel to the flow of fuel.

In preliminary tests of multi-cell-sheet device designs, electrical power outputs of 25 W to 100 W are readily achieved at voltages of 5V and currents of 5 A. Even for 100 W devices, the maximum current will remain below this value making device-to-device connections of slight cross-section possible. The high voltage, low current feature of these devices is an obvious advantage for stack construction, as is the accompanying elimination of traditional SOFC interconnect structures that present cost and durability concerns in thermal cycling environments. The costs of the metal-filled vias and device-to-device connections of slight cross-section will be more than recovered through the avoidance of the added cost and weight of standard planar interconnect structures.

The invention may be further understood by reference to the following specific examples, which are intended to be illustrative rather than limiting.

### EXAMPLE 1

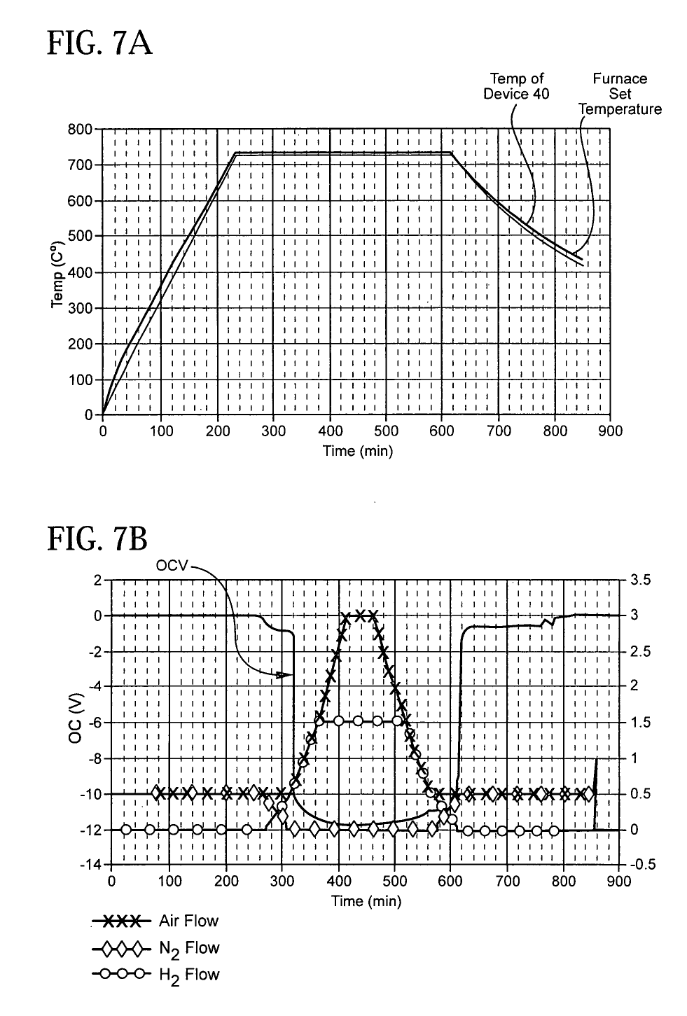

A first exemplary SOFC assembly 10 was made using the frame module 50 that utilizes two frames. This test SOFC assembly 10 measured 12 cm by 15 cm. The top frame 50B contains air inlet 51B connected to the tube 55B and an air outlet 54B connected to the distribution port 53B, and a cut out oxidant chamber 30′ to provide air to the device 40 as shown in the drawing of FIGS. 1A-1C and 4A-4C. The frame module 50 holds single 10-cell electrolyte supported multi-cell device 40. An alumina felt insulator 80 lies between the device 40 and each frame 50A, 50B of the frame module 50. The seal 60 is made directly between the device 40 and the outer edge of the frames 50A, 50B as seen in FIG. 1A, 1B and FIG. 3A. The seal 60 in embodiment is a ceramic filled boro-alumino-silicate glass. A frit paste is applied along the edge of the device 40 and frames 50A, 50B and heated to 800° C. to create the seal 60. Alternatively, a metal braze may be employed instead of the frit. The exterior seal design is especially advantageous for braze seals in that a locally reducing environment may be employed without fear of reduction of the already formed cathode material of the multi-cell device. The test conditions are described below and are illustrated in FIGS. 7A, 7B. More specifically, FIG. 1A illustrates the temperatures (OCV) measured on this assembly during testing, and the flow rates (1/min) of H₂, N₂ and air. A measured open circuit voltage with the absolute value of greater than 1.1 V/cell, 11V total, indicates good sealing with this design.

More specifically the test conditions were as follows: First, the portable fuel cell assembly was placed in a furnace. Next the fuel cell assembly was supplied with 0.5 L/min N₂ to the fuel chamber 30 and 0.5 L/min air to the oxidant chamber 30′. The device was then heated from room temperature to 725° C. at a rate of 3° C./min. The N₂ flow to the fuel chamber 30 was gradually decreased from 0.5 L/min to 0 L/min while, simultaneously, H₂ flow to that chamber was increased from 0 L/min to 0.5 L/min. Next, H₂ and air flows were increased simultaneously to 1.5 L/min H₂ and 3.0 L/min air, respectively. This condition is maintained for 50 minutes. H₂ and air flows were then decreased simultaneously to 0.5 L/min. The H₂ flow to the fuel chamber was then decreased further to 0 L/min while N₂ flow is increased from 0 L/min to 0.5 L/min. Finally the furnace set point was decreased from 725° C. to 2° C. at a rate of 3° C./min.

### EXAMPLE 2

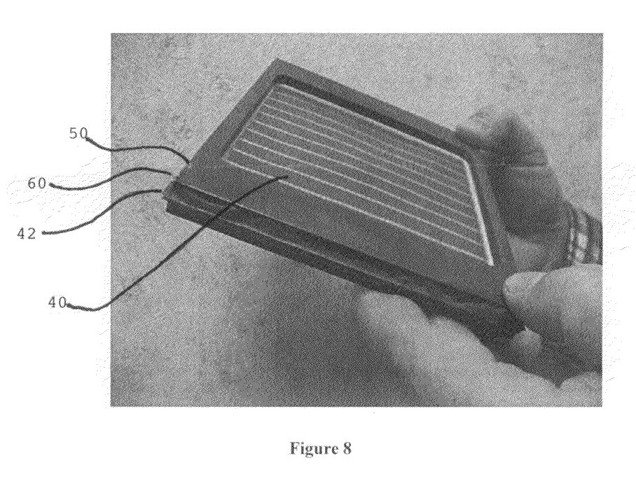

A second exemplary SOFC assembly 10 was also made using two frames 50A, 50B, a single 10-cell device 40, alumina felt pads 80, and an external glass seal 60. This SOFC assembly 10 shown in FIG. 8 and its external dimensions are 11.6 cm by 14.5 cm by 1.05 cm. This SOFC assembly 10 illustrates the thermal-mechanical robustness of the design and shows clearly how the device 40 is held between the two frames 50A, 50B, with alumina pads 80 situated between device 40 and frames 50A, 50B, and glass seals 60 at the exterior of the frame module 50. This assembly, including the device 40 has been hated to 800° C. to form the seals 60 and was then successfully cooled without failure. This SOFC assembly also illustrates one embodiment of the invention where the air needed to run the device is supplied by an external means and not through the use of the air chamber 30′ as in the SOFC assembly 10 of Example 1. These frames should be open frames as shown in this example. The frame module 50 of this embodiment utilizes a seal 60 that is made at the external edge of the frame module 50 and all manifolding is exterior manifolding. In this design, the fuel and air seals are formed together for each device 40.

Of course, the foregoing description and examples are merely illustrative of the invention, it being apparent to those of skill in these arts that numerous variations and/or modifications of the particular materials, devices and methods hereinabove described may be resorted to for the practice of the invention as set forth in the following claims.

We claim:

1. A portable solid oxide fuel cell assembly comprising:
(i) a single multi-cell device;
(ii) a frame module supporting said device, said frame module providing air and fuel to said device, said frame forming, in conjunction with said device, a single air chamber adjacent to one side of said device, and a single fuel chamber adjacent to the other side of said device;
wherein said device generates more than 3V of electricity and has a maximum dimension of no more than 0.5 meter.

2. The portable solid oxide fuel cell assembly of claim 1, wherein said device not smaller than said frame.

3. The portable solid oxide fuel cell assembly of claim 1 further comprising:
an external seal sealing said device to said frame module.

4. The portable solid oxide fuel cell assembly of claim 3 wherein said frame module includes an external recess for receiving sealant material.

5. The portable solid oxide fuel cell assembly of claim 1 further comprising a felt situated between said single multi-cell device and said frame module, said felt providing electrical insulation.

6. The portable solid oxide fuel cell assembly of claim 5, wherein said felt provides electrical insulation, of at least 1 KΩ.

7. The portable solid oxide fuel cell assembly of claim 1 wherein said frame module includes a heat exchanger for heating incoming fuel.

8. The portable solid oxide fuel cell assembly of claim 1 wherein said frame module includes a heat exchanger for heating incoming oxidant.

9. The portable solid oxide fuel cell assembly of claim 1 wherein said frame module includes a biscuit cut for fuel distribution.

10. The portable solid oxide fuel cell assembly of claim 1 wherein said solid oxide fuel cell assembly has exterior dimensions of not larger than 9″×12″×3″.

11. The portable solid oxide fuel cell assembly of claim 1 wherein said solid oxide fuel cell assembly has the largest dimension no larger than 6″.

12. The portable solid oxide fuel cell assembly of claim 11 wherein said solid oxide fuel cell assembly generates at least 5 Watts of electrical power.

13. The portable solid oxide fuel cell assembly of claim 1 wherein said solid oxide fuel cell assembly the largest dimension no larger than 3″.

14. The portable solid oxide fuel cell assembly of claim 13 wherein said solid oxide fuel cell assembly generates at least 5 Watts of electrical power.

15. The portable solid oxide fuel cell assembly of claim 14 wherein said solid oxide fuel cell assembly generates at least 10 Watts of electrical power.

16. The portable solid oxide fuel cell assembly of claim 1 wherein said solid oxide fuel cell assembly the largest dimension no larger than 1″.

17. The portable solid oxide fuel cell assembly of claim 16 wherein said solid oxide fuel cell assembly generates at least 1 Watt of electrical power.

18. The portable solid oxide fuel cell assembly of claim 1 wherein said solid oxide fuel cell assembly weights less than 10 kg.

19. The portable solid oxide fuel cell assembly of claim 1 wherein said solid oxide fuel cell assembly weights less than 5 kg.

20. A portable solid oxide fuel cell assembly comprising:
(i) at least one multi-cell device formed at least in part by a compliant electrolyte sheet;
(ii) a frame module supporting said device, said frame module providing air and fuel to said device, said frame forming, in conjunction with said device at least one of: a single fuel chamber, a single air chamber adjacent to the active area of at least one multi-cell device;
wherein said at least one multi-cell device generates more than 3V of electricity and has a maximum dimension of no more than 0.5 meter.

21. An assembly in accordance with claim 20 wherein the electrical conductor elements interconnect the anodes and cathodes on said electrolyte sheet.

22. An assembly in accordance with claim 20 wherein the fuel delivery supplying a hydrogen-containing fuel gas to the enclosed interior of the assembly.

23. An assembly in accordance with claim 20 that develops at least 10 watts of electrical power.

24. An assembly in accordance with claim 20 having exterior dimensions of not larger than 9″×12″×3″ and that develops an electrical potential in excess of 5 volts.

25. The portable solid oxide fuel cell assembly comprising wherein said device generates more than 12V of electricity.
